(19) United States
(12) Patent Application Publication
(10) Pub. No.: US 2024/0029449 A1
(43) Pub. Date: Jan. 25, 2024

(54) VEHICLE BEHAVIOR INFERENCE APPARATUS, UNSAFE DRIVING DETECTION APPARATUS, AND METHOD

(71) Applicant: NEC Corporation, Tokyo (JP)

(72) Inventors: Yasunori FUTATSUGI, Tokyo (JP); Yasuhiro MIZUKOSHI, Tokyo (JP)

(73) Assignee: NEC Corporation, Tokyo (JP)

(21) Appl. No.: 18/025,327

(22) PCT Filed: Sep. 25, 2020
(86) PCT No.: PCT/JP2020/036317

§ 371 Date: Mar. 8, 2023

(51) Int. Cl. G06V 20/56; G06V 20/40; G06V 20/59; G06T 7/215

(52) U.S. Cl. CPC G06V 20/588; G06V 20/41; G06V 20/597; G06T 7/215; G06T 2207/10016; G06T 2207/30252; G06T 2207/30268

(57) ABSTRACT

A movement vector calculation unit calculates movement vectors between frames of a video image of an area ahead of a vehicle. The video image is input as a moving image. An area inference unit infers an area indicating a movable object included in the video image of the area ahead of the vehicle. A vector excluding unit excludes, from among the calculated movement vectors, movement vectors in an area inferred as being the area indicating the movable object. A behavior inference unit infers behavior of the vehicle based on the movement vectors from which those in the area inferred as being the area indicating the movable object have been excluded.

### TECHNICAL FIELD

The present disclosure relates to a vehicle behavior inference apparatus, an unsafe driving detection apparatus, a method, and a computer readable medium.

### BACKGROUND ART

As related art, Patent Literature 1 discloses a reckless driving analysis apparatus that extracts (i.e., detects) reckless driving. The reckless driving analysis apparatus disclosed in Patent Literature 1 acquires driving information and operation information of a vehicle. The driving information includes information about the speed and the acceleration of the vehicle. The operation information includes whether or not the brake is applied, the steering angle, whether or not the turn signal indicator is turned on, and whether or not the accelerator is pressed. Based on the driving information and the operation information, the reckless driving analysis apparatus determines the driving conditions such as whether the vehicle is traveling in a straight line, is turning to the right or to the left, or is in a standstill state. The reckless driving analysis apparatus specifies a reckless driving pattern based on the location of the vehicle on a map and the driving conditions.

As another related art, Patent Literature 2 discloses a surrounding-area monitoring apparatus that detects obstacles present around a vehicle. The surrounding-area monitoring apparatus disclosed in Patent Literature 2 extracts feature points from a video image of an area around the vehicle taken (e.g., captured) by a camera. The surrounding-area monitoring apparatus specifies feature points that are moving at a speed in a predetermined speed range in an area near the extracted feature points, and tracks the specified feature points. The surrounding-area monitoring apparatus groups together, from among the feature points moving at the speed in the predetermined speed range, the feature points that have been inferred to constitute the same moving object into one group, and tracks the grouped feature points.

The above-described surrounding-area monitoring apparatus determines whether or not the vehicle is turning at a speed in a predetermined vehicle speed range based on signals output from a vehicle-speed sensor, a steering angle sensor, and a yaw-rate sensor. When the surrounding-area monitoring apparatus determines that the vehicle is turning, it determines whether or not the movement vectors of all the feature points belonging to the same group point in a specific direction corresponding to the turning direction. The surrounding-area monitoring apparatus determines that a group of which the movement vectors of all the feature points do not point in the specific direction is a group corresponding to a moving object, and visually informs the driver of the presence of the moving object. The surrounding-area monitoring apparatus determines that a group of which the movement vectors of all the feature points point in the specific direction is not a group corresponding to a moving object, and thus does not inform the driver thereof.

### CITATION LIST

### Patent Literature

Patent Literature 1: Japanese Unexamined Patent Application Publication No. 2011-227571
Patent Literature 2: Japanese Unexamined Patent Application Publication No. 2015-158874

### SUMMARY OF INVENTION

### Technical Problem

In Patent Literature 1, information about the vehicle speed, the steering angle, and the like acquired from the vehicle is used to determine the driving conditions of the vehicle (i.e., the behavior of the vehicle). Therefore, the reckless driving analysis apparatus disclosed in Patent Literature 1 needs to be connected to the in-vehicle network of the vehicle in order to acquire such information from the vehicle. Similarly, the surrounding-area monitoring apparatus disclosed in Patent Literature 2 determines whether or not the vehicle is turning by using information acquired from the vehicle. Therefore, the surrounding-area monitoring apparatus needs to be connected to the in-vehicle network of the vehicle.

In view of the above-described circumstances, an object of the present disclosure is to provide a vehicle behavior inference apparatus, an unsafe driving detection apparatus, a vehicle behavior inference method, an unsafe driving detection method, and a computer readable medium capable of inferring the behavior of a vehicle even when the apparatus or the like is not connected to the in-vehicle network of the vehicle.

### Solution to Problem

To achieve the above-described object, in a first aspect, the present disclosure provides a vehicle behavior inference apparatus. The vehicle behavior inference apparatus includes: movement vector calculation means for calculating movement vectors between frames of a video image of an area ahead of a vehicle, the video image being input as a moving image; area inference means for inferring an area indicating a movable object included in the video image of the area ahead of the vehicle; vector excluding means for excluding, from among the calculated movement vectors, movement vectors in an area inferred as being the area indicating the movable object; and behavior inference means for inferring behavior of the vehicle based on the movement vectors from which those in the area inferred as being the area indicating the movable object have been excluded.

In a second aspect, the present disclosure provides an unsafe driving detection apparatus. The unsafe driving detection apparatus includes: movement vector calculation means for calculating movement vectors between frames of a video image of an area ahead of a vehicle, the video image being input as a moving image; area inference means for inferring an area indicating a movable object included in the video image of the area ahead of the vehicle; vector excluding means for excluding, from among the calculated movement vectors, movement vectors in an area inferred as being the area indicating the movable object; behavior inference means for inferring behavior of the vehicle based on the movement vectors from which those in the area inferred as being the area indicating the movable object have been excluded; surrounding-area information acquisition means for acquiring surrounding-area information of the vehicle; posture information acquisition means for acquiring posture information of a driver of the vehicle; and unsafe driving detection means for detecting unsafe driving of the vehicle based on at least one of the inferred behavior of the vehicle, the surrounding-area information of the vehicle, or the posture information of the driver.

In a third aspect, the present disclosure provides a vehicle behavior inference method. The vehicle behavior inference method includes: calculating movement vectors between frames of a video image of an area ahead of a vehicle, the video image being input as a moving image; inferring an area indicating a movable object included in the video image of the area ahead of the vehicle; excluding, from among the calculated movement vectors, movement vectors in an area inferred as being the area indicating the movable object; and inferring behavior of the vehicle based on the movement vectors from which those in the area inferred as being the area indicating the movable object have been excluded.

In a fourth aspect, the present disclosure provides an unsafe driving detection method. The unsafe driving detection method includes: calculating movement vectors between frames of a video image of an area ahead of a vehicle, the video image being input as a moving image; inferring an area indicating a movable object included in the video image of the area ahead of the vehicle; excluding, from among the calculated movement vectors, movement vectors in an area inferred as being the area indicating the movable object; inferring behavior of the vehicle based on the movement vectors from which those in the area inferred as being the area indicating the movable object have been excluded; acquiring surrounding-area information of the vehicle; acquiring posture information of a driver of the vehicle; and detecting unsafe driving of the vehicle based on at least one of the inferred behavior of the vehicle, the surrounding-area information of the vehicle, or the posture information of the driver.

In a fifth aspect, the present disclosure provides a computer readable medium. The computer readable media stores a program for causing a processor to perform processes including: calculating movement vectors between frames of a video image of an area ahead of a vehicle, the video image being input as a moving image; inferring an area indicating a movable object included in the video image of the area ahead of the vehicle; excluding, from among the calculated movement vectors, movement vectors in an area inferred as being the area indicating the movable object; and inferring behavior of the vehicle based on the movement vectors from which those in the area inferred as being the area indicating the movable object have been excluded.

In a sixth aspect, the present disclosure provides a computer readable medium. The computer readable media stores a program for causing a processor to perform processes including: calculating movement vectors between frames of a video image of an area ahead of a vehicle, the video image being input as a moving image; inferring an area indicating a movable object included in the video image of the area ahead of the vehicle; excluding, from among the calculated movement vectors, movement vectors in an area inferred as being the area indicating the movable object; inferring behavior of the vehicle based on the movement vectors from which those in the area inferred as being the area indicating the movable object have been excluded; acquiring surrounding-area information of the vehicle; acquiring posture information of a driver of the vehicle; and detecting unsafe driving of the vehicle based on at least one of the inferred behavior of the vehicle, the surrounding-area information of the vehicle, or the posture information of the driver.

### Advantageous Effects of Invention

A vehicle behavior inference apparatus, an unsafe driving detection apparatus, a vehicle behavior inference method, an unsafe driving detection method, and a computer readable medium according to the present disclosure can infer the behavior of a vehicle even when the apparatus or the like is not connected to the in-vehicle network of the vehicle.

### BRIEF DESCRIPTION OF DRAWINGS

FIG. 1 is a block diagram showing a vehicle behavior inference apparatus according to the present disclosure;

FIG. 2 is a block diagram showing an unsafe driving detection apparatus including a vehicle behavior inference apparatus;

FIG. 3 is a block diagram showing an unsafe driving detection apparatus according to a first example embodiment of the present disclosure;

FIG. 4 shows an example of a result of area recognition;

FIG. 5 is a flowchart showing an operating procedure performed by an unsafe driving detection apparatus;

FIG. 6 shows movement vectors in each image when a vehicle turns left;

FIG. 7 shows movement vectors in each image when a vehicle turns right;

FIG. 8 is a block diagram showing an unsafe driving detection apparatus according to a third example embodiment of the present disclosure; and

FIG. 9 is a block diagram showing a hardware configuration of an electronic apparatus.

### EXAMPLE EMBODIMENT

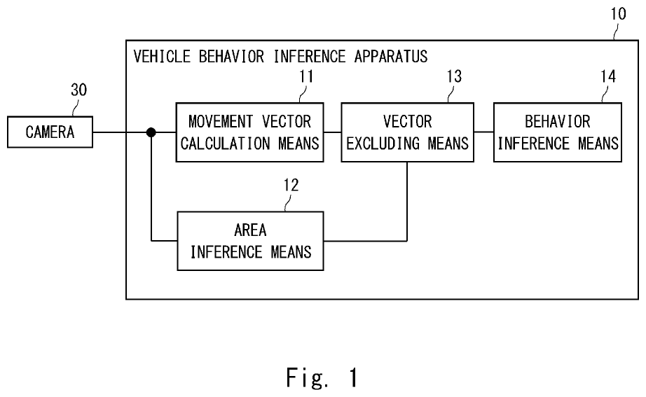

An overview of the present disclosure will be described prior to describing an example embodiment according to the present disclosure. FIG. 1 shows a vehicle behavior inference apparatus according to the present disclosure. The vehicle behavior inference apparatus 10 includes movement vector calculation means 11, area inference means 12, vector excluding means 13, and behavior inference means 14.

A moving image taken (e.g., captured) by a camera 30 is input to the movement vector calculation means 11. The camera 30 takes a moving image including a video image of an area ahead of the vehicle. The movement vector calculation means 11 calculates movement vectors between frames of the video image of the area ahead of the vehicle. The area inference means 12 infers an area(s) indicating a movable object(s) included (i.e., shown) in the video image of the area ahead of the vehicle taken by using the camera 30.

The vector excluding means 13 excludes, from among the movement vectors calculated by the movement vector calculation means 11, movement vectors in the area inferred by the area inference means 12 as being the area(s) indicating the movable object(s). The behavior inference means 14 infers the behavior of the vehicle based on the movement vectors from which those in the area inferred by the vector excluding means 13 as being the area of the movable object have been excluded.

Suppose that the behavior inference means 14 has inferred the behavior of the vehicle by using all the movement vectors calculated by the movement vector calculation means 11. In that case, if another vehicle(s), a person(s) (e.g., pedestrian(s)), or the like is included (i.e., shown) in the video image, there is a possibility that even when the vehicle is at a standstill, the behavior inference means may incorrectly infer that the vehicle is moving because the other vehicle(s) or the like is moving. In the present disclosure, the behavior inference means 14 infers the behavior of the vehicle based on, among the movement vectors calculated by the movement vector calculation means 11, the movement vectors of the area other than the area inferred as being the area of the movable object. In this way, the behavior inference means 14 can accurately infer the behavior of the vehicle without being influenced by the movement(s) of the other vehicle(s) or the like.

In the present disclosure, the vehicle behavior inference apparatus 10 can infer the behavior of the vehicle from the moving image including the video image of the area ahead of the vehicle. Therefore, the vehicle behavior inference apparatus 10 does not need to acquire information about the vehicle from the vehicle. The vehicle behavior inference apparatus 10 according to the present disclosure can accurately infer the behavior of the vehicle from the video image even when the vehicle behavior inference apparatus 10 is not connected to the in-vehicle network of the vehicle.

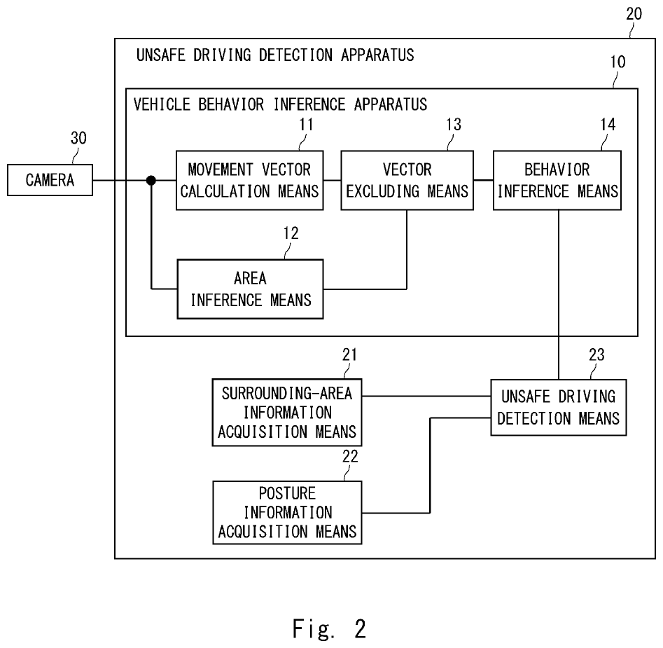

The above-described vehicle behavior inference apparatus 10 can be used for an unsafe driving detection apparatus. FIG. 2 shows an unsafe driving detection apparatus including the above-described vehicle behavior inference apparatus 10. The unsafe driving detection apparatus 20 includes, in addition to the vehicle behavior inference apparatus 10, surrounding-area information acquisition means 21, posture information acquisition means 22, and unsafe driving detection means 23.

The surrounding-area information acquisition means 21 acquires surrounding-area information of a vehicle (i.e., information about an area around a vehicle). The posture information acquisition means 22 acquires posture information of the driver of the vehicle (i.e., information about the posture of the driver). The unsafe driving detection means 23 detects unsafe driving of the vehicle based on at least one of the behavior of the vehicle inferred by the vehicle behavior inference apparatus 10, the surrounding-area information of the vehicle acquired by the surrounding-area information acquisition means 21, or the posture information of the driver acquired by the posture information acquisition means 22.

The unsafe driving detection apparatus 20 according to the present disclosure detects unsafe driving of the vehicle by using the behavior of the vehicle inferred by the vehicle behavior inference apparatus 10. As described above, the vehicle behavior inference apparatus 10 can accurately infer the behavior of the vehicle even when the vehicle behavior inference apparatus 10 is not connected to the in-vehicle network of the vehicle. Therefore, the unsafe driving detection apparatus 20 can detect unsafe driving by using the inferred behavior of the vehicle even when the unsafe driving detection apparatus 20 is not connected to the in-vehicle network of the vehicle.

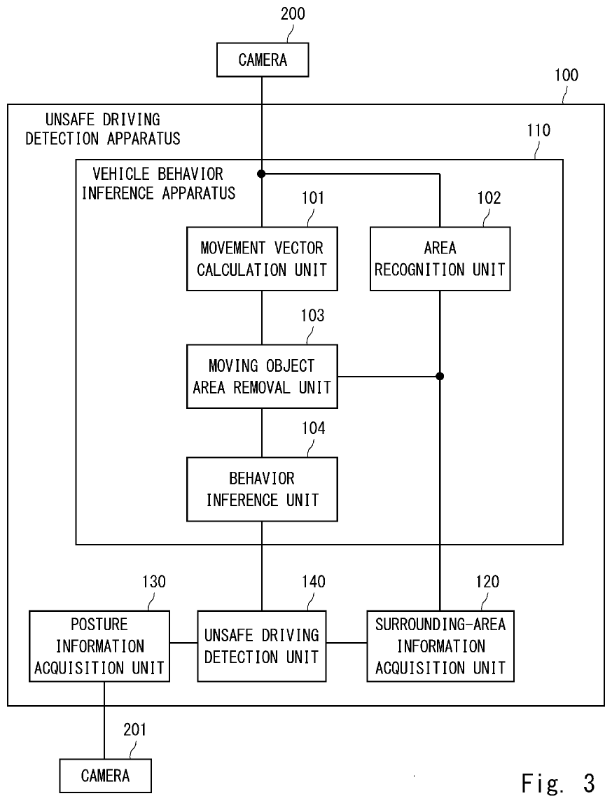

An example embodiment according to the present disclosure will be described hereinafter in detail. FIG. 3 shows an unsafe driving detection apparatus according to a first example embodiment of the present disclosure. The unsafe driving detection apparatus 100 includes a movement vector calculation unit 101, an area recognition unit 102, a moving-object area excluding unit 103, a behavior inference unit 104, a surrounding-area information acquisition unit 120, a posture information acquisition unit 130, and an unsafe driving detection unit 140. The movement vector calculation unit 101, the area recognition unit 102, the moving-object area excluding unit 103, and the behavior inference unit 104 constitute a vehicle behavior inference apparatus 110. The vehicle behavior inference apparatus 110 corresponds to the vehicle behavior inference apparatus 10 shown in FIG. 1.

The unsafe driving detection apparatus 100 is constructed, for example, as an electronic apparatus that can be retrofitted to a vehicle. The unsafe driving detection apparatus 100 may be incorporated into (i.e., built into) an electronic apparatus that is installed in a vehicle. For example, the unsafe driving detection apparatus 100 is incorporated into (e.g., built into) a dashboard camera including a camera that takes a video image of an area outside the vehicle and a controller that records the taken video image in a recording medium. The unsafe driving detection apparatus 100 does not need to be connected to the in-vehicle network or the like of the vehicle. In other words, the unsafe driving detection apparatus 100 does not have to be configured as an apparatus that can acquire information about the vehicle through a CAN (Controller Area Network) bus or the like. The unsafe driving detection apparatus 100 corresponds to the unsafe driving detection apparatus 20 shown in FIG. 2.

The vehicle behavior inference apparatus 110 infers the behavior of the vehicle by using the video image taken by using a camera 200 installed in the vehicle. The camera 200 takes a video image of an outside area ahead of the vehicle. The camera 200 is disposed, for example, at or near the base of the rearview mirror of the windshield in such a manner that the camera 200 faces the outside of the vehicle. The camera 200 may be, for example, a 360-degree camera that takes a video image(s) of areas ahead of, behind, to the right of, to the left of, and inside the vehicle. The camera 200 outputs the taken video image(s) to the vehicle behavior inference apparatus 110 as a moving image(s). The camera 200 may be a part of the vehicle behavior inference apparatus 110. The camera 200 corresponds to the camera 30 shown in FIG. 1.

The movement vector calculation unit 101 acquires the moving image including the video image of the area ahead of the vehicle from the camera 200. The movement vector calculation unit 101 calculates movement vectors between frames of the video image of the area ahead of the vehicle. The movement vector calculation unit 101 calculates, for example, a movement of each optical point between frames (i.e., calculates an optical flow). Any algorithm can be used to calculate the optical flow. In the case where the camera 200 is a camera that also takes video images of areas other than the area ahead of the vehicle, such as a 360-degree camera, the movement vector calculation unit 101 may calculate an optical flow for, among the moving images, the moving image of the area corresponding to the video image of the area ahead of the vehicle. The movement vector calculation unit 101 corresponds to the movement vector calculation means 11 shown in FIG. 1.

The area recognition unit 102 performs an area recognition process on the video image taken by the camera 200. For example, the area recognition unit 102 infers, in each frame, what object or the like an area of each pixel corresponds. For example, the area recognition unit 102 infers which of an automobile, a person, a motorcycle, a road, a building, the sky, planting, and a roadside mark such as a white line each pixel corresponds. In particular, the area recognition unit 102 infers an area that indicates a movable object included (i.e., shown) in the video image of the area ahead of the vehicle. The area recognition unit 102 infers an area corresponding to a vehicle such as an automobile or a motorcycle, and an area of a person (e.g., a pedestrian) as areas of movable objects. The area recognition unit 102 corresponds to the area inference means 12 shown in FIG. 1.

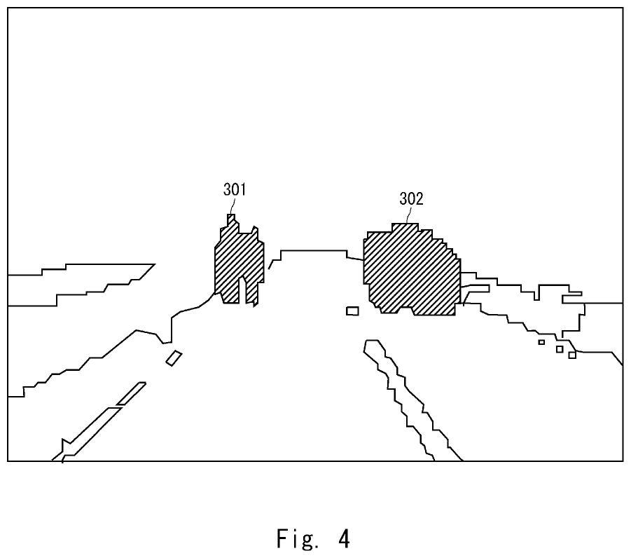

FIG. 4 shows an example of the result of the area recognition. In the example shown in FIG. 4, a person area 301 and a vehicle area 302 present on the road recognized by the area recognition unit 102 are shown. The area recognition unit 102 outputs the result of the area recognition including the person area 301 and the vehicle area 302 to the moving-object area excluding unit 103 and the surrounding-area information acquisition unit 120. The area recognition unit 102 may output, to the moving-object area excluding unit 103, only information indicating an area(s) of a movable object(s) as the area recognition result.

The moving-object area excluding unit 103 refers to the area recognition result obtained by the area recognition unit 102, and thereby excludes, from among the movement vectors calculated by the movement vector calculation unit 101, the movement vectors in the area inferred as being the area of the movable object. For example, the moving-object area excluding unit 103 excludes the movement vectors in the person area 301 and the vehicle area 302 from the optical flow of the video image of the area ahead of the vehicle. The moving-object area excluding unit 103 outputs the optical flow, from which the movement vectors in the areas of the movable objects have been excluded, to the behavior inference unit 104. The moving-object area excluding unit 103 corresponds to the vector excluding means 13 shown in FIG. 1.

The behavior inference unit 104 refers to the optical flow input from the moving-object area excluding unit 103, from which the areas of the movable objects have been excluded, and thereby infers the behavior of the vehicle. For example, the behavior inference unit 104 infers, based on the optical flow, whether the vehicle is moving, at a standstill, turning right, or turning left. For example, when the magnitudes of the movement vectors are equal to or smaller than a predetermined threshold, the behavior inference unit 104 infers that the vehicle is at a standstill. For example, when the magnitudes of the movement vectors are larger than the predetermined threshold, the behavior inference unit 104 infers that the vehicle is moving. The behavior inference unit 104 infers, for example, whether the vehicle is turning right or turning left based on the directions of the movement vectors. The behavior inference unit 104 corresponds to the behavior inference means 14 shown in FIG. 1.

The surrounding-area information acquisition unit 120 acquires information about an area around the vehicle (i.e., surrounding-area information of the vehicle). In this example embodiment, the surrounding-area information acquisition unit 120 acquires the information about the area around the vehicle by referring to the result of the area recognition performed by the area recognition unit 102. For example, the surrounding-area information acquisition unit 120 acquires the surrounding-area information of the vehicle by referring to the area including a vehicle, the area indicating a person, the area indicating a road, and the area indicating a road mark inferred by the area recognition unit 102. For example, the surrounding-area information acquisition unit 120 acquires, as the surrounding-area information of the vehicle, information indicating whether or not there are another vehicle(s) and/or a person(s) near the vehicle, information indicating whether or not there is a pedestrian crossing ahead of the vehicle, and the like. The surrounding-area information acquisition unit 120 corresponds to the surrounding-area information acquisition means 21 shown in FIG. 2.

The posture information acquisition unit 130 acquires posture information of the driver of the vehicle. The posture information acquisition unit 130 may acquire the posture information of the driver, for example, from a video image taken by using a camera 201. The camera 201 takes a video image of the interior of the vehicle, including the driver seat. For example, the posture information acquisition unit 130 infers the skeletal structure of the driver from a video image of the driver, and infers the posture of the driver based on the inferred skeletal structure. The camera 201 may be a part of the unsafe driving detection apparatus 100. In the case where the camera 200 is a camera that takes a video image of the interior of the vehicle, such as a 360-degree camera, the posture information acquisition unit 130 may acquire the posture information of the driver by using the video image taken by the camera 200. In that case, the camera 201 is not indispensable. The posture information acquisition unit 130 corresponds to the posture information acquisition means 22 shown in FIG. 2.

The unsafe driving detection unit 140 detects unsafe driving of the vehicle based on at least one of the behavior of the vehicle inferred by the behavior inference unit 104, the surrounding-area information acquired by the surrounding-area information acquisition unit 120, or the posture information of the driver acquired by the posture information acquisition unit 130. For example, the unsafe driving detection unit 140 determines the direction of the face or the like of the driver based on the posture information of the driver, and thereby determines whether or not the driver is looking aside. Further, the unsafe driving detection unit 140 determines whether or not a hand of the driver is close to his/her head based on the posture information of the driver, and thereby determines whether or not the driver is performing an action other than the driving. The unsafe driving detection unit 140 determines, for example, the presence/absence of another vehicle(s) and the presence/absence of a pedestrian crossing based on the surrounding-area information. The unsafe driving detection unit 140 detects unsafe driving based on a combination of the behavior of the vehicle, the posture of the driver, and the situation in the surrounding area. Examples of the unsafe driving include driving that may cause a danger and driving that does not comply with predetermined rules.

The unsafe driving detection unit 140 stores, for example, conditions for detecting unsafe driving. The unsafe driving detection unit 140 determines whether or not a combination of the behavior of the vehicle, the posture of the driver, and the situation in the surrounding area meets the conditions for detecting unsafe driving. The unsafe driving detection unit 140 detects unsafe driving when it determines that the combination meets the conditions for detecting unsafe driving. For example, the unsafe driving detection unit 140 detects unsafe driving when the vehicle is moving; the posture of the driver indicates that the driver is looking aside; and there is another vehicle(s) near the vehicle. For example, when the vehicle is at a standstill, the unsafe driving detection unit 140 determines that the vehicle is not in the unsafe driving state even when the posture of the driver indicates that the driver is looking aside and there is another vehicle(s) near the vehicle. The unsafe driving detection unit 140 corresponds to the unsafe driving detection means 23 shown in FIG. 2.

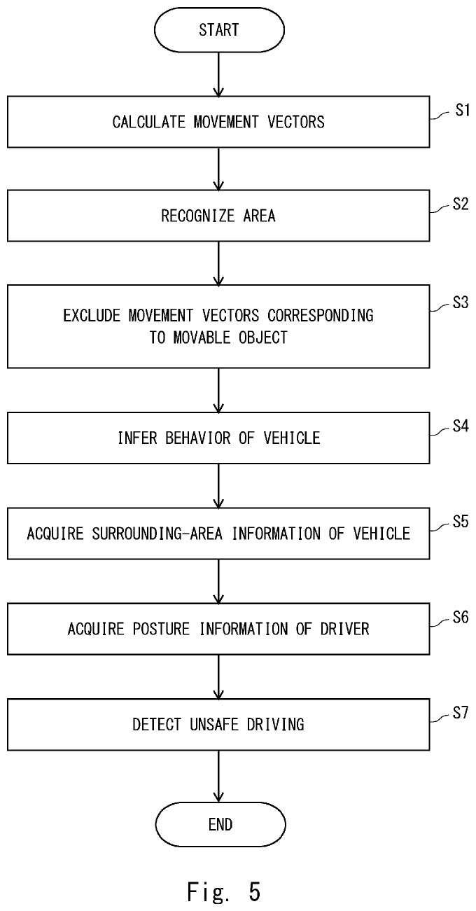

Next, an operating procedure will be described. FIG. 5 shows an operating procedure (an unsafe driving detection method) performed by the unsafe driving detection apparatus 100. The movement vector calculation unit 101 calculates a movement vector of each pixel between frames in the video image of the area ahead of the vehicle from the moving image input from the camera 200 (Step S1). The area recognition unit 102 performs area recognition on the video image of the area ahead of the vehicle input from the camera 200 (Step S2). In the step S2, the area recognition unit 102 specifies, for example, an area(s) of a movable object(s) included (i.e., shown) in the video image of the area ahead of the vehicle.

The moving-object area excluding unit 103 refers to the result of the area recognition obtained in the step S2, and thereby excludes movement vectors corresponding to the area(s) of the movable object(s) from the movement vectors calculated in the step S1 (Step S3). The behavior inference unit 104 infers the behavior of the vehicle based on the movement vectors from which those in the area of the movable object have been excluded in the step S3 (Step S4). The steps S1 to S4 correspond to a vehicle behavior inference method performed in the vehicle behavior inference apparatus 110.

The surrounding-area information acquisition unit 120 acquires surrounding-area information of the vehicle (Step S5). In the step S5, the surrounding-area information acquisition unit 120 acquires, for example, the surrounding-area information of the vehicle based on the result of the area recognition obtained in the step S2. The posture information acquisition unit 130 acquires posture information of the driver of the vehicle (Step S6). In the step S6, for example, the posture information acquisition unit 130 may infer the skeletal structure of the driver based on the video image taken by using the camera 201, and acquire the posture information of the driver based on the inferred skeletal structure.

The unsafe driving detection unit 140 detects unsafe driving based on at least one of the behavior of the vehicle inferred in the step S4, the surrounding-area information of the vehicle acquired in the step S5, or the posture information of the driver acquired in the step S6 (Step S7). In the step S7, the unsafe driving detection unit 140 detects unsafe driving when, for example, a combination of the behavior of the vehicle, the surrounding-area information of the vehicle, and the posture information of the driver meets predetermined conditions. When the unsafe driving detection unit 140 has detected unsafe driving, it may notify the driver of the detection of the unsafe driving by outputting a warning sound from a speaker or the like.

In this example embodiment, the moving-object area excluding unit 103 excludes, from among the movement vectors calculated by the movement vector calculation unit 101, movement vectors in an area(s) specified as the area(s) of a movable object(s) by the area recognition unit 102. The behavior inference unit 104 infers the behavior of the vehicle by using the movement vectors from which those in the area of the movable object have been excluded by the moving-object area excluding unit 103. In this example embodiment, the behavior inference unit 104 can infer the behavior of the vehicle by excluding movement vectors in an area(s) that may move independently of the movement of the vehicle. As a result, the behavior inference unit 104 can accurately infer the behavior of the vehicle. Further, in this example embodiment, the vehicle behavior inference apparatus 110 uses a video image taken by using the camera 200 in order to infer the behavior of the vehicle. Therefore, the vehicle behavior inference apparatus 110 does not need to acquire information about the vehicle speed, the steering angle, and the like from the vehicle, and hence does not need to be connected to the in-vehicle network of the vehicle. The unsafe driving detection apparatus 100 can detect unsafe driving based on the inferred behavior of the vehicle even when the unsafe driving detection apparatus 100 is not connected to the in-vehicle network of the vehicle.

Next, a second example embodiment according to the present disclosure will be described. A configuration of an unsafe driving detection apparatus according to the second example embodiment of the present disclosure may be the same as the configuration of the unsafe driving detection apparatus 100 described in the first example embodiment shown in FIG. 3. In this example embodiment, the vehicle behavior inference apparatus 110 infers the behavior of the vehicle by using not only the video image of the area ahead of the vehicle but also a video image of an area to the right of the vehicle and a video image of an area to the left thereof. The rest of the operations may be similar to those in the first example embodiment.

In this example embodiment, the camera 200 is constructed, for example, as a 360-degree camera, and takes video images of areas ahead of, to the right of, and to the left of the vehicle. The video image of the area to the right of the vehicle is, for example, a video image of an area outside the right-side window of the front seat of the vehicle. The video image of the area to the left of the vehicle is, for example, a video image of an area outside the left-side window of the front seat of the vehicle. Instead of taking video images of areas ahead of, to the right of, and to the left of the vehicle by using one camera, video images of areas ahead of, to the right of, and to the left of the vehicle may be taken by using a plurality of cameras.

The movement vector calculation unit 101 calculates, in addition to the movement vectors between frames of the video image of the area ahead of the vehicle, movement vectors between frames of the video image of the area to the right of the vehicle and movement vectors between frames of the video image of the area to the left of the vehicle. The movement vector calculation unit 101 calculates, for example, the movement vectors between frames of the video image of the area ahead of the vehicle by using a video image of an area corresponding to the windshield of the vehicle in the moving image taken by using the 360-degree camera. The movement vector calculation unit 101 calculates, for example, the movement vectors between frames of the video image of the area to the right of the vehicle by using a video image of an area corresponding to the right-side window of the vehicle in the moving image taken by using the 360-degree camera. The movement vector calculation unit 101 calculates, for example, the movement vectors between frames of the video image of the area to the left of the vehicle by using a video image of an area corresponding to the left-side window of the vehicle in the moving image taken by using the 360-degree camera.

The area recognition unit 102 performs area recognition not only on the video image of the area ahead of the vehicle but also on the video image of the area to the right of the vehicle and the video image of the area to the left of the vehicle. The area recognition unit 102 specifies an area(s) indicating a movable object(s) included (i.e., shown) in the video image of the area to the right of the vehicle, and an area(s) indicating a movable object(s) included (i.e., shown) in the video image of the area to the left of the vehicle. The area recognition unit 102 performs, for example, area recognition on the video image of the area corresponding to the windshield of the vehicle in the moving image taken by using the 360-degree camera. The area recognition unit 102 performs area recognition on the video image of the area corresponding to the right-side window of the vehicle in the moving image taken by using the 360-degree camera. The area recognition unit 102 performs area recognition on the video image of the area corresponding to the left-side window of the vehicle in the moving image taken by using the 360-degree camera.

The moving-object area excluding unit 103 excludes movement vectors in the area of the movable object included in the video image of the area ahead of the vehicle from the movement vectors between frames of the video image of the area ahead of the vehicle. Further, the moving-object area excluding unit 103 excludes movement vectors in the area of the movable object included in the video image of the area to the right of the vehicle from the movement vectors between frames of the video image of the area to the right of the vehicle. Further, the moving-object area excluding unit 103 excludes movement vectors in the area of the movable object from the movement vectors between frames of the video image of the area to the left of the vehicle.

The behavior inference unit 104 infers the behavior of the vehicle based on the movement vectors of the video image of the area ahead of the vehicle, the movement vectors of the video image of the area to the right of the vehicle, and the movement vectors of the video image of the area to the left of the vehicle, from each of which movement vectors in the area(s) of the movable object(s) have been excluded. The behavior inference unit 104 infers the behavior of the vehicle, for example, based mainly on the movement vectors of the video image of the area ahead of the vehicle. The behavior inference unit 104 may infer whether the vehicle is turning right or turning left by using the movement vectors of the video image of the area to the right of the vehicle and those of the video image of the area to the left of the vehicle in a supplemental manner.

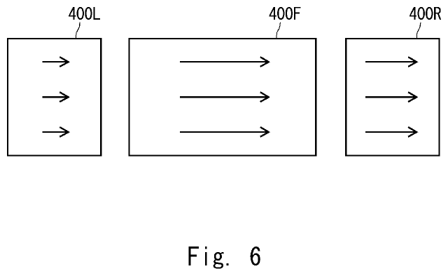

FIG. 6 shows movement vectors in each image when the vehicle turns left. In FIG. 6, movement vectors (an optical flow) 400F represent movement vectors calculated from the video image of the area ahead of the vehicle. Movement vectors 400R represent movement vectors calculated from the video image of the area to the right of the vehicle. Movement vectors 400L represent movement vectors calculated from the video image of the area to the left of the vehicle. In the movement vectors 400F, 400R and 400L, movement vectors in an area(s) of a movable object(s) have been excluded by the moving-object area excluding unit 103.

It is considered that when the vehicle turns left, all the movement vectors 400F, 400R and 400L generally point to the right. It is considered that, in this state, since the radiuses of the rotations of the right side and the left side of the vehicle differ from each other, the magnitudes of the movement vectors 400R in the video image of the area to the right of the vehicle and the movement vectors 400L in the video image of the area to the left of the vehicle differ from each other. The behavior inference unit 104 calculates a difference between the magnitudes of the movement vectors 400R in the video image of the area to the right of the vehicle and those of the movement vectors 400L in the video image of the area to the left of the vehicle. The behavior inference unit 104 infers whether the vehicle is turning right or turning left based on the difference between the movement vectors in the left and right video images, and the movement vectors 400F in the video image of the area ahead of the vehicle. As shown in FIG. 6, the behavior inference unit 104 may infer that the vehicle is turning left when the movement vectors 400F in the video image of the area ahead of the vehicle point to the right and the magnitudes of the movement vectors 400L are smaller than those of the movement vectors 400R.

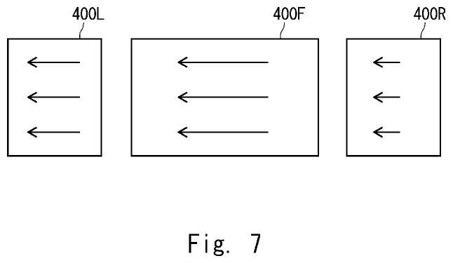

FIG. 7 shows movement vectors in each image when a vehicle turns right. It is considered that when the vehicle turns right, contrary to the above-described situation, all the movement vectors 400F, 400R and 400L generally point to the left. It is considered that, in this state, because of the difference between the radiuses of the rotations of the vehicle, the magnitudes of the movement vectors 400R in the video image of the area to the right of the vehicle and the movement vectors 400L in the video image of the area to the left of the vehicle differ from each other. As shown in FIG. 7, the behavior inference unit 104 may infer that the vehicle is turning right when the movement vectors in the video image of the area ahead of the vehicle point to the left and the magnitudes of the movement vectors 400R are smaller than those of the movement vectors 400L.

In this example embodiment, the behavior inference unit 104 infers the behavior of the vehicle by using, in addition to the movement vectors of the video image of the area ahead of the vehicle, the movement vectors of the video image of the area to the right of the vehicle and those of the video image of the area to the left of the vehicle. The behavior inference unit 104 can accurately infer whether the vehicle is turning right or turning left by referring to the difference between the magnitudes of the movement vectors in the video image of the area to the right of the vehicle and those of the video images of the area to the left of the vehicle. The rest of the effects are similar to those in the first example embodiment.

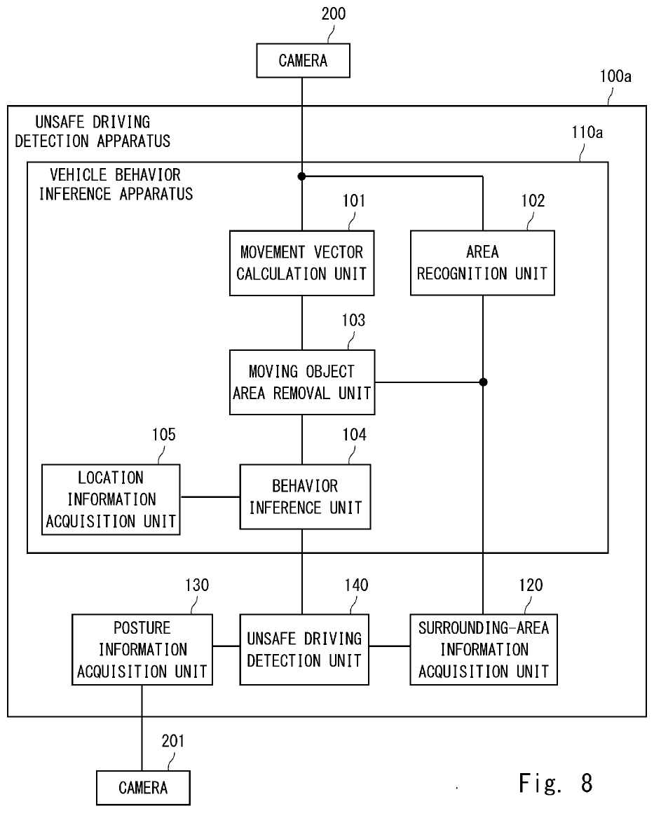

Next, a third example embodiment according to the present disclosure will be described. FIG. 8 shows an unsafe driving detection apparatus according to the third example embodiment of the present disclosure. An unsafe driving detection apparatus 100a according to the present disclosure differs from the unsafe driving detection apparatus 100 according to the first example embodiment shown in FIG. 3 in that the vehicle behavior inference apparatus 110a includes a location information acquisition unit 105. In this example embodiment, similarly to the second example embodiment, the behavior inference unit 104 may infer the behavior of the vehicle by further using movement vectors of the video image of the area to the right of the vehicle and movement vectors of the video image of the area to the left of the vehicle.

The location information acquisition unit 105 acquires location information of the vehicle (i.e., information about the location of the vehicle). The location information acquisition unit 105 acquires the location information of the vehicle by using, for example, the GNSS (Global Navigation Satellite System). The behavior inference unit 104 infers the behavior of the vehicle by using movement vectors from which those in an area(s) of a movable object(s) have been excluded and the location information acquired by the location information acquisition unit 105. For example, the behavior inference unit 104 may correct the result of the inference about the behavior of the vehicle which has been made based on the movement vectors based on the change in the location information of the vehicle.

In this example embodiment, the behavior inference unit 104 infers the behavior of the vehicle by using, in addition to the movement vectors calculated by the movement vector calculation unit 101, the location information acquired by the location information acquisition unit 105. For example, the behavior inference unit 104 can infer whether or not the vehicle is moving, and can infer in what direction the vehicle is moving by referring to the location information in a chronological manner. Therefore, the behavior inference unit 104 can infer the behavior of the vehicle more accurately.

Note that although an example in which the vehicle behavior inference apparatus 110 is included in the unsafe driving detection apparatus 100 has been described in the above-described example embodiment, the present disclosure is not limited to this example. The vehicle behavior inference apparatus 110 and the unsafe driving detection apparatus 100 may be constructed as separate apparatuses. Further, although an example in which the behavior of the vehicle inferred by the vehicle behavior inference apparatus 110 is used in the unsafe driving detection apparatus 100 in the above-described example embodiment, the present disclosure is not limited to this example. The vehicle behavior inference apparatus 110 may output the result of the inference about the behavior of the vehicle to an apparatus other than the unsafe driving detection apparatus 100.

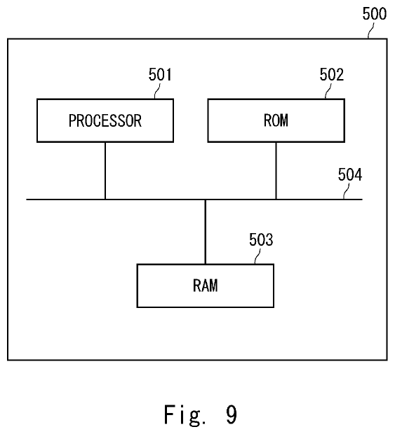

In the present disclosure, the unsafe driving detection apparatus 100 and the vehicle behavior inference apparatus 110 may be constructed as an electronic apparatus(es) including a processor(s). FIG. 9 shows a hardware configuration of an electronic apparatus that can be used for the unsafe driving detection apparatus 100 and the vehicle behavior inference apparatus 110. The electronic apparatus 500 includes a processor 501, a ROM (read only memory) 502, and a RAM (random access memory) 503. In the electronic apparatus 500, the processor 501, the ROM 502, and the RAM 503 are connected to each other through a bus 504. The electronic apparatus 500 may include other circuits such as peripheral circuits and interface circuits though they are not shown in the drawing.

The ROM 502 is a nonvolatile storage device. For the ROM 502, a semiconductor storage device such as a flash memory having a relatively small capacity is used. The ROM 502 stores a program(s) to be executed by the processor 501.

The aforementioned program can be stored and provided to the electronic apparatus 500 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to the electronic apparatus by using any type of transitory computer readable media. Examples of transitory computer readable media include electric signals, optical signals, and electromagnetic waves. Transitory computer readable media can provide the program to the electronic apparatus via a wired communication line such as electric wires and optical fibers or a radio communication line.

The RAM 503 is a volatile storage device. As the RAM 503, various types of semiconductor memory apparatuses such as a DRAM (Dynamic Random Access Memory) or an SRAM (Static Random Access Memory) can be used. The RAM 540 can be used as an internal buffer for temporarily storing data or the like.

The processor 501 expands (i.e., loads) a program stored in the ROM 502 in the RAM 503, and executes the expanded (i.e., loaded) program. As the processor 501 executes the program, the function of each unit of the unsafe driving detection apparatus 100 and the vehicle behavior inference apparatus 110 can be implemented.

Although example embodiments according to the present disclosure have been described above in detail, the present disclosure is not limited to the above-described example embodiments, and the present disclosure also includes those that are obtained by making changes or modifications to the above-described example embodiments without departing from the scope of the present disclosure.

The whole or part of the example embodiments disclosed above can be described as, but not limited to, the following Supplementary notes.

### [Supplementary Note 1]

A vehicle behavior inference apparatus comprising:
movement vector calculation means for calculating movement vectors between frames of a video image of an area ahead of a vehicle, the video image being input as a moving image;
area inference means for inferring an area indicating a movable object included in the video image of the area ahead of the vehicle;
vector excluding means for excluding, from among the calculated movement vectors, movement vectors in an area inferred as being the area indicating the movable object; and
behavior inference means for inferring behavior of the vehicle based on the movement vectors from which those in the area inferred as being the area indicating the movable object have been excluded.

### [Supplementary Note 2]

The vehicle behavior inference apparatus described in Supplementary note 1, wherein the movement vector calculation means calculates a movement of each optical point between frames as the movement vector.

### [Supplementary Note 3]

The vehicle behavior inference apparatus described in Supplementary note 1 or 2, wherein the behavior inference means infers whether the vehicle is moving, at a standstill, turning right, or turning left.

### [Supplementary Note 4]

The vehicle behavior inference apparatus described in any one of Supplementary notes 1 to 3, wherein the movement vector calculation means calculates movement vectors between frames of the video image of the area ahead of the vehicle by using a video image of an area corresponding to the area ahead of the vehicle in a moving image taken by using a 360-degree camera.

### [Supplementary Note 5]

The vehicle behavior inference apparatus described in any one of Supplementary notes 1 to 4, wherein
the movement vector calculation means further calculates movement vectors between frames of a video image of an area to the right of the vehicle and movement vectors between frames of a video image of an area to the left of the vehicle, the video image of the area to the right and the video image of the area to the left of the vehicle each being input as a moving image,
the area inference means further infers an area indicating a movable object included in the video image of the area to the right of the vehicle and an area indicating a movable object included in the video image of the area to the left of the vehicle, and
the vector excluding means further excludes a movement vector in an area inferred as being the area indicating the movable object from the movement vectors between frames of the video image of the area to the right of the vehicle and from the movement vectors between frames of the video image of the area to the left of the vehicle.

### [Supplementary Note 6]

The vehicle behavior inference apparatus described in Supplementary note 5, wherein the behavior inference means infers whether the vehicle is turning right or turning left based on a difference between the movement vectors between the frames of the video image of the area to the right of the vehicle from which those in the area inferred as being the area indicating the movable object have been excluded and the movement vectors between the frames of the video image of the area to the left of the vehicle from which those in the area inferred as being the area indicating the movable object have been excluded, and the movement vectors between the frames of the video image of the area ahead of the vehicle from which those in the area inferred as being the area indicating the movable object have been excluded.

### [Supplementary Note 7]

The vehicle behavior inference apparatus described in Supplementary note 5 or 6, wherein the movement vector calculation means calculates the movement vectors between frames of the video image of the area to the right of the vehicle by using a video image of an area corresponding to the area to the right of the vehicle in a moving image taken by using a 360-degree camera, and calculates the movement vector between frames of the video image of the area to the left of the vehicle by using a video image of an area corresponding to the area to the left of the vehicle in the moving image taken by using the 360-degree camera.

### [Supplementary Note 8]

The vehicle behavior inference apparatus described in any one of Supplementary notes 1 to 7, further comprising location measurement means for measuring a location of the vehicle, wherein
the behavior inference means infers the behavior of the vehicle based also on a result of the measurement of location of the vehicle.

### [Supplementary Note 9]

An unsafe driving detection apparatus comprising:
movement vector calculation means for calculating movement vectors between frames of a video image of an area ahead of a vehicle, the video image being input as a moving image;
area inference means for inferring an area indicating a movable object included in the video image of the area ahead of the vehicle;
vector excluding means for excluding, from among the calculated movement vectors, movement vectors in an area inferred as being the area indicating the movable object;
behavior inference means for inferring behavior of the vehicle based on the movement vectors from which those in the area inferred as being the area indicating the movable object have been excluded;
surrounding-area information acquisition means for acquiring surrounding-area information of the vehicle;
posture information acquisition means for acquiring posture information of a driver of the vehicle; and
unsafe driving detection means for detecting unsafe driving of the vehicle based on at least one of the inferred behavior of the vehicle, the surrounding-area information of the vehicle, or the posture information of the driver.

### [Supplementary Note 10]

The unsafe driving detection apparatus described in Supplementary note 9, wherein
the area inference means further infers an area indicating a road and an area indicating a road mark, and
the surrounding-area information acquisition means acquires the surrounding-area information of the vehicle based on the inferred area indicating the road and the area indicating the road mark.

### [Supplementary Note 11]

The unsafe driving detection apparatus described in Supplementary note 9 or 10, wherein the posture information acquisition means acquires posture information of a driver of the vehicle based on a video image obtained by photographing the driver of the vehicle.

### [Supplementary Note 12]

A vehicle behavior inference method comprising:
calculating movement vectors between frames of a video image of an area ahead of a vehicle, the video image being input as a moving image;
inferring an area indicating a movable object included in the video image of the area ahead of the vehicle;
excluding, from among the calculated movement vectors, movement vectors in an area inferred as being the area indicating the movable object; and
inferring behavior of the vehicle based on the movement vectors from which those in the area inferred as being the area indicating the movable object have been excluded.

### [Supplementary Note 13]

An unsafe driving detection method comprising:
calculating movement vectors between frames of a video image of an area ahead of a vehicle, the video image being input as a moving image;
inferring an area indicating a movable object included in the video image of the area ahead of the vehicle;
excluding, from among the calculated movement vectors, movement vectors in an area inferred as being the area indicating the movable object;
inferring behavior of the vehicle based on the movement vectors from which those in the area inferred as being the area indicating the movable object have been excluded;
acquiring surrounding-area information of the vehicle;
acquiring posture information of a driver of the vehicle; and
detecting unsafe driving of the vehicle based on at least one of the inferred behavior of the vehicle, the surrounding-area information of the vehicle, or the posture information of the driver.

### [Supplementary Note 14]

A non-transitory computer readable media storing a program for causing a processor to perform processes including:
calculating movement vectors between frames of a video image of an area ahead of a vehicle, the video image being input as a moving image;
inferring an area indicating a movable object included in the video image of the area ahead of the vehicle;
excluding, from among the calculated movement vectors, movement vectors in an area inferred as being the area indicating the movable object; and
inferring behavior of the vehicle based on the movement vectors from which those in the area inferred as being the area indicating the movable object have been excluded.

### [Supplementary Note 15]

A non-transitory computer readable media storing a program for causing a processor to perform processes including:
calculating movement vectors between frames of a video image of an area ahead of a vehicle, the video image being input as a moving image;
inferring an area indicating a movable object included in the video image of the area ahead of the vehicle;
excluding, from among the calculated movement vectors, movement vectors in an area inferred as being the area indicating the movable object;
inferring behavior of the vehicle based on the movement vectors from which those in the area inferred as being the area indicating the movable object have been excluded;
acquiring surrounding-area information of the vehicle;
acquiring posture information of a driver of the vehicle; and
detecting unsafe driving of the vehicle based on at least one of the inferred behavior of the vehicle, the surrounding-area information of the vehicle, or the posture information of the driver.

### REFERENCE SIGNS LIST

10 VEHICLE BEHAVIOR INFERENCE APPARATUS
11 MOVEMENT VECTOR CALCULATION MEANS
12 AREA INFERENCE MEANS
13 VECTOR EXCLUDING MEANS
14 BEHAVIOR INFERENCE MEANS
20 UNSAFE DRIVING DETECTION APPARATUS
21 SURROUNDING-AREA INFORMATION ACQUISITION MEANS
22 POSTURE INFORMATION ACQUISITION MEANS
23 UNSAFE DRIVING DETECTION MEANS
30 CAMERA
100 UNSAFE DRIVING DETECTION APPARATUS
101 MOVEMENT VECTOR CALCULATION UNIT
102 AREA RECOGNITION UNIT
103 MOVING OBJECT AREA REMOVAL UNIT
104 BEHAVIOR INFERENCE UNIT
105 LOCATION INFORMATION ACQUISITION UNIT
110 VEHICLE BEHAVIOR INFERENCE APPARATUS
120 SURROUNDING-AREA INFORMATION ACQUISITION UNIT
130 POSTURE INFORMATION ACQUISITION UNIT
140 UNSAFE DRIVING DETECTION UNIT
200, 201 CAMERA

What is claimed is:

1. A vehicle behavior inference apparatus comprising:
a memory storing instructions; and
a processor configured to execute the instructions to:
calculate movement vectors between frames of a video image of an area ahead of a vehicle, the video image being input as a moving image;
infer an area indicating a movable object included in the video image of the area ahead of the vehicle;
exclude, from among the calculated movement vectors, movement vectors in an area inferred as being the area indicating the movable object; and
infer behavior of the vehicle based on the movement vectors from which those in the area inferred as being the area indicating the movable object have been excluded.

2. The vehicle behavior inference apparatus according to claim 1, wherein the processor is configured to execute the instructions to calculate a movement of each optical point between frames as the movement vector.

3. The vehicle behavior inference apparatus according to claim 1, wherein the processor is configured to execute the instructions to infer whether the vehicle is moving, at a standstill, turning right, or turning left.

4. The vehicle behavior inference apparatus according to claim 1, wherein the processor is configured to execute the instructions to calculate movement vectors between frames of the video image of the area ahead of the vehicle by using a video image of an area corresponding to the area ahead of the vehicle in a moving image taken by using a 360-degree camera.

5. The vehicle behavior inference apparatus according to claim 1, wherein
the processor is further configured to execute the instructions to:
calculate movement vectors between frames of a video image of an area to the right of the vehicle and movement vectors between frames of a video image of an area to the left of the vehicle, the video image of the area to the right and the video image of the area to the left of the vehicle each being input as a moving image,
infer an area indicating a movable object included in the video image of the area to the right of the vehicle and an area indicating a movable object included in the video image of the area to the left of the vehicle, and
exclude a movement vector in an area inferred as being the area indicating the movable object from the movement vectors between frames of the video image of the area to the right of the vehicle and from the movement vectors between frames of the video image of the area to the left of the vehicle.

6. The vehicle behavior inference apparatus according to claim 5, wherein the processor is configured to execute the instructions to infer whether the vehicle is turning right or turning left based on a difference between the movement vectors between the frames of the video image of the area to the right of the vehicle from which those in the area inferred as being the area indicating the movable object have been excluded and the movement vectors between the frames of the video image of the area to the left of the vehicle from which those in the area inferred as being the area indicating the movable object have been excluded, and the movement vectors between the frames of the video image of the area ahead of the vehicle from which those in the area inferred as being the area indicating the movable object have been excluded.

7. The vehicle behavior inference apparatus according to claim 5, wherein the processor is configured to execute the instructions to calculate the movement vectors between frames of the video image of the area to the right of the vehicle by using a video image of an area corresponding to the area to the right of the vehicle in a moving image taken by using a 360-degree camera, and calculate the movement vector between frames of the video image of the area to the left of the vehicle by using a video image of an area corresponding to the area to the left of the vehicle in the moving image taken by using the 360-degree camera.

8. The vehicle behavior inference apparatus according to claim 1, the processor is further configured to execute the instructions to
measure a location of the vehicle, and
infer the behavior of the vehicle based on, in addition to the movement vectors from which those in the area inferred as being the area indicating the movable object have been excluded, a result of the measurement of location of the vehicle.

9. An unsafe driving detection apparatus comprising:
the vehicle behavior inference apparatus according to claim 1,
wherein the processor is further configured to execute the instructions to:
acquire surrounding-area information of the vehicle;
acquire posture information of a driver of the vehicle; and
detect unsafe driving of the vehicle based on at least one of the inferred behavior of the vehicle, the surrounding-area information of the vehicle, or the posture information of the driver.

10. The unsafe driving detection apparatus according to claim 9, wherein
the processor is further configured to execute the instructions to:
infer an area indicating a road and an area indicating a road mark, and
acquire the surrounding-area information of the vehicle based on the inferred area indicating the road and the area indicating the road mark.

11. The unsafe driving detection apparatus according to claim 9, wherein the processor is configured to execute the instructions to acquire acquires posture information of a driver of the vehicle based on a video image obtained by photographing the driver of the vehicle.

12. A vehicle behavior inference method comprising:
calculating movement vectors between frames of a video image of an area ahead of a vehicle, the video image being input as a moving image;
inferring an area indicating a movable object included in the video image of the area ahead of the vehicle;
excluding, from among the calculated movement vectors, movement vectors in an area inferred as being the area indicating the movable object; and
inferring behavior of the vehicle based on the movement vectors from which those in the area inferred as being the area indicating the movable object have been excluded.

13. An unsafe driving detection method comprising:
calculating movement vectors between frames of a video image of an area ahead of a vehicle, the video image being input as a moving image;
inferring an area indicating a movable object included in the video image of the area ahead of the vehicle;
excluding, from among the calculated movement vectors, movement vectors in an area inferred as being the area indicating the movable object;
inferring behavior of the vehicle based on the movement vectors from which those in the area inferred as being the area indicating the movable object have been excluded;
acquiring surrounding-area information of the vehicle;
acquiring posture information of a driver of the vehicle; and
detecting unsafe driving of the vehicle based on at least one of the inferred behavior of the vehicle, the surrounding-area information of the vehicle, or the posture information of the driver.

14-15. (canceled)
